(19) United States
(12) Patent Application Publication
(10) Pub. No.: US 2026/0307057 A1
(43) Pub. Date: Oct. 8, 2026

(54) CORAL-REEF-LIKE BIFUNCTIONAL CATALYST FOR BIOMASS GASIFICATION TO PRODUCE GREEN HYDROGEN WITH SIMULTANEOUS DECARBONIZATION, AND PREPARATION METHOD AND APPLICATION THEREOF

(71) Applicant: SOUTHEAST UNIVERSITY, Nanjing (CN)

(72) Inventors: Huiyan ZHANG, Nanjing (CN); Qiuxiang LU, Nanjing (CN); Yinhai SU, Nanjing (CN); Rui XIAO, Nanjing (CN)

(73) Assignee: SOUTHEAST UNIVERSITY, Nanjing (CN)

(21) Appl. No.: 19/655,747

(22) Filed: Apr. 23, 2026

Related U.S. Application Data
(63) Continuation of application No. PCT/CN2025/105009, filed on Jun. 27, 2025.

(30) Foreign Application Priority Data
Apr. 3, 2025 (CN) 202510418050.X

(51) Int. Cl. B01J 23/78; B01J 21/10; B01J 23/94; B01J 37/00; B01J 37/02; B01J 37/04; B01J 37/08; B01J 38/02; C10J 3/02

(52) U.S. Cl. CPC B01J 23/78; B01J 21/10; B01J 23/94; B01J 37/0036; B01J 37/0201; B01J 37/0236; B01J 37/04; B01J 37/088; B01J 38/02; C10J 3/02; C10J 2300/092; C10J 2300/0976; C10J 2300/0986

(57) ABSTRACT

A coral-reef-like bifunctional catalyst for biomass gasification to co-produce green hydrogen and achieve decarbonization. Active metal site regulation optimizes the matching between active phases and supports to enhance catalytic activity and stability. The unique coral-reef-like structure builds a confined space for bond cleavage and CO₂ conversion. Dual active sites respectively drive directional bond cleavage for high-purity green hydrogen production and in-situ CO₂ adsorption and conversion. The catalyst exhibits excellent cyclic stability and couples multiple reaction pathways, realizing efficient preparation of high H₂/CO (3.8) syngas and possessing promising application potential.

### CROSS REFERENCE TO THE RELATED APPLICATIONS

This application is a continuation application of International Application No. PCT/CN2025/105009, filed on Jun. 27, 2025, which is based upon and claims priority to Chinese Patent Application No. 202510418050.X, filed on Apr. 3, 2025, the entire contents of which are incorporated herein by reference.

### TECHNICAL FIELD

The present disclosure belongs to the technical field of catalyst preparation and biomass high-value utilization and particularly to a coral-reef-like bifunctional catalyst for biomass gasification to produce green hydrogen with simultaneous decarbonization and a preparation method thereof, and further to an application of the above coral-reef-like bifunctional catalyst in production of a bio-based hydrogen-rich synthesis gas.

### BACKGROUND

Hydrogen energy is a zero-carbon, clean and efficient energy source as well as an important approach for various countries in the world to cope with climate changes and realize the carbon neutrality targets. Currently, the direct reforming of the fossil fuels is a major means of hydrogen supply, about accounting for 96% of the global hydrogen source and 98.5% of the domestic hydrogen source. The massive industry of hydrogen production with fossil fuels generates at least 300 million tons of carbon emission and faces the huge pressure of low-carbon transformation. The biomass is the sole renewable carbon source on the earth, and the biomass resource potential of China is equivalent to 1 billion tons of standard coals, having a huge potential to produce green hydrogen on scale. The total biomass resource available for energy utilization each year in China is about 460 million tons of standard coals, 40% of which are used for fodder, fertilizers and industrial materials and about 60% have not been effectively utilized yet. Therefore, the production of hydrogen with the biomass as raw material is an important approach to mitigating energy crisis.

Pyrolysis is an important method for current biomass resource utilization, in which the biomass is converted into a hydrogen-rich gas product at high temperature. However, the high oxygen content and water content of the biomass lead to high CO₂ content and low green hydrogen yield and H₂/CO in the pyrolysis synthesis gas. In the current researches, it is mainly aimed to increase the hydrogen yield in the synthesis gas by the methods such as developing reactor and optimizing reaction conditions and so on, but the hydrogen production efficiency is not improved noticeably. Compared with the pyrolysis, the catalytic pyrolysis has the advantages of short reaction time and high hydrogen yield and so on, bringing remarkable technical advantages and broad industrialization prospect.

Although the catalytic pyrolysis technology can improve the hydrogen production efficiency, there are still some key problems to be solved, in particular, a catalyst with good reactivity and high hydrogen selectivity applicable to large-scale application is to be developed. The current researches demonstrate that the noble metal catalysts are highly reactive but their high prices severely limit their large-scale applications; non-noble metal (alkali metals, alkaline earth metals and transition metals) catalysts suffer carbon deposition and deactivation in the thermal chemical conversion, leading to low hydrogen production efficiency and high tar content and so on.

Based on the above, from the viewpoint of the characteristics of the products of thermal chemical conversion of the biomass, in order to produce high-purity hydrogen by the thermal chemical conversion of biomass, it is required to prepare a catalyst with low preparation costs, good stability, high reactivity, ease of regeneration, carbon deposition resistance, and coupling of two actives sites for hydrogen production and decarbonization.

### SUMMARY

One of the objects of the present disclosure is to provide a preparation method of a coral-reef-like bifunctional catalyst for biomass gasification to produce green hydrogen with simultaneous decarbonization, which features low preparation costs, good stability, high reactivity, ease of regeneration, carbon deposition resistance, and coupling of two actives sites for hydrogen production and decarbonization.

A second one of the objects of the present disclosure is to provide a coral-reef-like bifunctional catalyst for biomass gasification to produce green hydrogen with simultaneous decarbonization, which features low preparation costs, good stability, high reactivity, ease of regeneration, carbon deposition resistance, and coupling of two actives sites for hydrogen production and decarbonization.

A third one of the objects of the present disclosure is to provide an application of the coral-reef-like bifunctional catalyst for biomass gasification to produce green hydrogen with simultaneous decarbonization in the preparation of a bio-based hydrogen-rich synthesis gas.

In order to achieve one of the objects of the present disclosure, the following technical scheme is employed: a preparation method of a coral-reef-like bifunctional catalyst for biomass gasification to produce green hydrogen with simultaneous decarbonization, including the following steps:
S1, an aluminum oxide support goes through acid leaching, calcination and grinding to produce an activated aluminum oxide support; magnesium oxide is calcined and ground to produce an activated magnesium oxide;
S2, the activated aluminum oxide support and the activated magnesium oxide are mixed to produce a composite support;
S3, the composite support is mixed fully with an active phase precursor of iron and an active phase precursor of nickel in water and then dried, calcined and ground to produce the coral-reef-like bifunctional catalyst.

The overall idea and the inventive principle of the present disclosure are as follows:

For the shortcomings of the current catalysts in the preparation of the bio-based hydrogen-rich synthesis gas, the present disclosure provides a preparation method to prepare a coral-reef-like bifunctional catalyst, which realizes continuous and efficient preparation of high H₂/CO synthesis gas from biomass by means of the catalyst coupling two active sites of green hydrogen production and decarbonization.

In the composite supports of the present disclosure, a dual-support mode of “activated aluminium oxide support+activated magnesium oxide” is adopted. The aluminium oxide support is activated by calcination and acid leaching, and the active metals iron and nickel are anchored to the oxygen vacancies of the activated aluminium oxide support as active sites for green hydrogen production. The metal anchoring enables the catalyst to have a firmer structure and still maintain special coral-reef-like morphology after five cycles and regenerations, maintaining high catalytic activity. Further, the activated magnesium oxide support, as a decarbonization center, in the application of the catalytic preparation of the hydrogen-rich synthesis gas, abstracts one oxygen atom from CO₂ to form an MgO(O) intermediate and further realizes carbon dioxide deoxygenation (MgO+CO₂→MgO(O)+CO). Compared with other decarbonization materials (e.g. CaO), the activated magnesium oxide undergoes little-to-no carbonation reaction in the decarbonization process and can maintain an original morphological structure and high activity in multiple cycles, leading to excellent cycling stability.

Seen from the preparation method, the catalyst preparation method provided by the present disclosure has the advantages of simple flow, mild conditions, relative inexpensive precursor and solvent, short cycle and low equipment requirements and so on; seen from the characteristics of the catalyst, the catalyst has the characteristics of low active metal loading, good dispersion, and stable structure and so on and also, the active phase of the catalyst is a transition metal, which is lower in preparation cost than that of the noble metal catalyst; seen from function, the catalyst has the advantages of high hydrogen production and decarbonization activity, ease of regeneration and carbon deposition resistance and so on.

Furthermore, in the step S1, the aluminum oxide support is γ-Al₂O₃; compared with other supports, γ-Al₂O₃ has higher activity in the catalytic conversion of biomass. The acid leaching uses a nitric acid solution with a concentration of 0.1 to 2 mol/L and an acid leaching time is 2 to 4 h; a calcination temperature of the aluminum oxide support is 600 to 900° C., and a time is 2 to 4 hours; the calcination is carried out in an inert atmosphere.

Furthermore, in the step S1, the calcination temperature of a magnesium oxide is 700 to 900° C. and a time is 1.5 to 3.5 h; the calcination is carried out in an inert atmosphere.

Furthermore, in the step S2, in the composite support, the weight ratio of the activated aluminum oxide support to the activated magnesium oxide is 1:4 to 4:1. In the composite support provided by the present disclosure, the aluminium oxide itself has a relatively stable structure with a general activity. In order to fully utilize the spatial configuration of aluminium oxide to load the active metals, the weight ratio of the aluminium oxide support to the magnesium oxide support is set in the above range. Preferably, in the composite support, a weight ratio of the activated aluminium oxide support to the activated magnesium oxide is 1:1 to 1:4. Under this condition, the composite support has not only the structural characteristics of special morphology and provision of oxygen vacancies but also sufficient decarbonization active sites.

Furthermore, in the step S3, the active phase precursor of iron includes a soluble iron salt and the active phase precursor of nickel includes a soluble nickel salt. The soluble iron salt includes combination of one or more of ferric nitrate, ferric chloride and ferric sulfate; the soluble nickel salt includes combination of one or more of nickel chloride, nickel sulfate and nickel acetate.

Furthermore, in the step S3, in the active phase precursor of iron and the active phase precursor of nickel, a molar ratio of iron element to nickel element is 1:3 to 3:1. In the preparation process of the catalyst, through the calcination treatment in the step S3, the active components iron and nickel are combined to form an alloy. The iron itself has a low activity and can agglomerate in case of too high content, leading to catalyst deactivation; although the nickel has a high activity, the catalyst tends to deactivate due to poisoning. In the present disclosure, through extensive researches and explorations, different molar ratios are designed to find that, within the above range, both iron and nickel can maintain good activity. Preferably, when the elemental molar ratio of the iron and nickel is 1:1, the Fe_{0.64}Ni_{0.36} alloy is more easily formed, obtaining a better catalytic activity.

Furthermore, in the step S3, the mixing is carried out at the stirring speed of 600 to 900 r/min under a mixing temperature of 60 to 100° C. for a time of 2 to 3 hours; the calcination is carried out in an inert atmosphere at a calcination temperature of 700 to 900° C. for a time of 3 to 4 h.

The technical scheme provided by the second of the objects of the present disclosure is to provide a coral-reef-like bifunctional catalyst for biomass gasification to produce green hydrogen with simultaneous decarbonization, which is prepared by the preparation method according to one of the objects of the present disclosure.

The coral-reef-like bifunctional catalyst includes a γ-Al₂O₃ support with regular tetrahedron structure and an active MgO support for decarbonization; active metals iron and nickel are anchored to oxygen vacancies of the γ-Al₂O₃ support and loading of the active metals iron and nickel relative to a total weight of the catalyst is 8 wt. % to 10 wt. %.

The technical scheme provided by the third of the objects of the present disclosure is to provide an application of the coral-reef-like bifunctional catalyst according to the second of the objects of the present disclosure in the preparation of a bio-based hydrogen-rich synthesis gas.

Furthermore, the application includes: mixing a dried biomass feedstock and the coral-reef-like bifunctional catalyst at a ratio, and performing pyrolysis reaction with water as gasifying agent to prepare a hydrogen-rich synthesis gas; where, in the hydrogen-rich synthesis gas, a molar ratio of H₂ to CO is 2 to 4.

Furthermore, in the application, the weight ratio of the dried biomass feedstock to the coral-reef-like bifunctional catalyst is 1:0.1 to 1.5; the biomass feedstock includes combination of one or more of wheat straw, corn straw, rice straw and bagasse.

Furthermore, in the pyrolysis reaction, the reaction temperature is 400-700° C.; the temperature of the reforming is 600-900° C. The reactor is a three-zone tubular furnace, with its temperatures respectively being 750-900° C., 650-800° C. and 500-700° C. from top down; the weight ratio of the injection amount of the gasifying agent water to the biomass feedstock is 1.6 to 9.8 mg/g.

Preferably, the velocity of the carrier gas (nitrogen) passing through the bed of the catalyst before reaction is 0.04 to 0.30 m/min, and the reaction process is set to 0.02 to 0.13 m/min; the flow rate of the gasifying agent water is maintained at 0.08 to 0.48 mL/min, and the corresponding nitrogen flow rate is 0.04 to 0.30 m/min.

In some preferred examples, in the coral-reef-like bifunctional catalyst, the weight ratio of the active γ-Al₂O₃ support and the active MgO support is 1:4, the loading of the active metals iron and nickel relative to the total weight of the catalyst is 9 wt. %, and the elemental molar ratio of the iron to the nickel is 1:1. In the application of the catalyst in the preparation of the bio-based hydrogen-rich syn-gas, the two pathways of bond cleavage, decarbonylation, and water-gas shift reaction are coupled to realize the molar ratio of H₂ to CO in the hydrogen-rich synthesis gas is 3.84.

Furthermore, the application further includes: the deactivated catalyst after use is treated by combustion to generate a regenerated catalyst, where the combustion temperature is 600 to 800° C. and the time is 30 to 80 min. By combustion treatment, the carbon deposit on the surfaces of the catalyst can be removed to restore its activity and realize regeneration.

Compared with the prior arts, the present disclosure has the following beneficial effects.
(1) In the preparation method of the coral-reef-like bifunctional catalyst for biomass gasification to produce green hydrogen with simultaneous decarbonization in the present disclosure, a coral-reef-like catalyst was directionally constructed via an impregnation-high temperature calcination method, where the metal-siting is used to regulate the matching between the active phase and the support. This preparation method features simple flow, mild conditions, relatively inexpensive precursor and solvent, short preparation period, use of general equipment and application to batch production.
(2) In the coral-reef-like bifunctional catalyst for biomass gasification to produce green hydrogen with simultaneous decarbonization in the present disclosure, a composite support composed of active aluminum oxide support and active magnesium oxide has two active sites for green hydrogen production and decarbonization. By using the active site for green hydrogen production, directional bond cleavage is performed in the thermal chemical conversion to increase the content of green hydrogen in the synthesis gas; the active site for decarbonization of the catalyst absorbs and converts CO₂ in the synthesis gas to lower the content of CO₂ at the outlet of the reactor. In addition, the unique spatial configuration of the support provides a confined environment required by bond cleavage and CO₂ conversion. The coral-reef-like bifunctional catalyst prepared in the present disclosure has the characteristics of low loading of active metal, good dispersion, stable structure and so on, and the active phase of the catalyst is a transition metal which is lower in preparation cost than the noble metal catalyst.
(3) The coral-reef-like bifunctional catalyst prepared in the present disclosure has coral-reef-like special morphology, and the coral-reef-like bifunctional catalyst exhibits excellent performance in preparation of the hydrogen-rich synthesis gas by thermal conversion of biomass, and has the features of good catalytic activity, high stability and strong carbon deposit resistance and so on. When the coral-reef-like bifunctional catalyst is applied to thermal chemical conversion of biomass, a high H₂/CO (molar ratio is 3.84) synthesis gas is directionally prepared by coupling two processes of green hydrogen production by chemical bond cleavage, decarbonylation, and water-gas shift reaction, realizing resource high-value utilization of the biomass and bringing broad promotion and application prospect.

### BRIEF DESCRIPTION OF THE DRAWINGS

FIG. 1 is a flowchart illustrating a preparation method of a coral-reef-like bifunctional catalyst for biomass gasification to produce green hydrogen with simultaneous decarbonization according to an example of the present disclosure.

FIGS. 2A-2C are SEM images of a surface of 3Fe1Ni/1MgO4Al₂O₃ catalyst prepared in the example 1; where FIG. 2A and FIG. 2B are SEM images and FIG. 2C is a TEM image.

FIGS. 3A-3B are distribution diagrams of gas products in a synthesis gas prepared in the application of the catalyst prepared in the example 1, where FIG. 3A is a gas product distribution diagram with different injection amounts of the gasifying agent (H₂O); and FIG. 3B is an H₂/CO comparison diagram of fresh catalyst, and cycled and regenerated catalysts.

FIG. 4 is a gas product distribution diagram under the varying ratios of active phase to support in examples 1 to 9 (without gasifying agent).

FIG. 5 is a real-time distribution curve of gases in a synthesis gas under the action of the catalyst prepared in the example 1 (without gasifying agent).

FIG. 6 is a real-time distribution curve of gases in a synthesis gas under the action of the catalyst prepared in the example 8 (without gasifying agent).

FIGS. 7A-7B show a gas product distribution and a catalyst crystal type after cycling and regeneration of the catalyst provided by the example 8 under the action of the gasifying agent; where FIG. 7A is a gas product distribution after five cycles and regenerations of the catalyst; FIG. 7B is a catalyst crystal type after five cycles and regenerations.

FIG. 8 is an EDX-mapping diagram of the 1Fe1Ni/4MgO1Al₂O₃ catalyst prepared in the example 8.

FIG. 9 is an EPR analysis diagram of the 1Fe1Ni/4MgO1Al₂O₃ catalyst prepared in the example 8.

FIG. 10 is a SEM-EDX analysis diagram of the 1Fe1Ni/4MgO1Al₂O₃ catalyst prepared in the example 8.

### DETAILED DESCRIPTION OF THE EMBODIMENTS

The technical schemes of the present disclosure will be fully and clearly described below in combination with the examples. Apparently, the described examples are only some examples of the present disclosure rather than all examples. All other examples obtained by those skilled in the arts based on the examples of the present disclosure without carrying out creative work shall fall within the scope of protection of the present disclosure.

It should be noted that in case of no conflicts, the examples of the present disclosure and the features in the examples can be mutually combined.

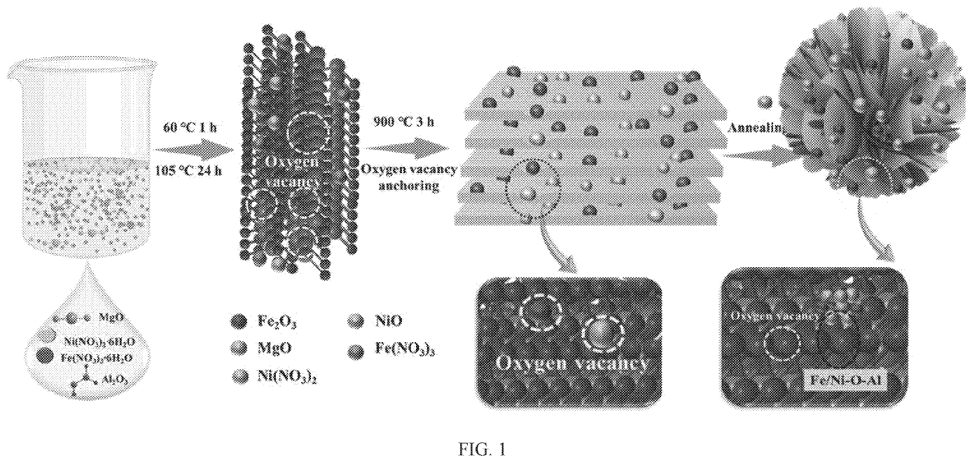

An embodiment of the present disclosure provides a preparation method of a coral-reef-like bifunctional catalyst for biomass gasification to produce green hydrogen with simultaneous decarbonization, with its flow illustrated in FIG. 1. The method includes the following steps.
Step 1: an aluminum oxide support goes through acid leaching, calcination and grinding to produce an activated aluminum oxide support; magnesium oxide is calcined and ground to produce an activated magnesium oxide; the aluminum oxide support is γ-Al₂O₃; the acid leaching uses a nitric acid solution with a concentration of 0.1 to 2 mol/L and the acid leaching time is 2 to 4 hours; the calcination temperature of the aluminum oxide support is 600 to 900° C., and the time is 2 to 4 hours; the calcination temperature of the magnesium oxide is 700 to 900° C. and the time is 1.5 to 3.5 h; the calcination is carried out in an inert atmosphere.
Step 2: the activated aluminum oxide support and the activated magnesium oxide are mixed at a weight ratio of 1:4 to 4:1 to produce a composite support.
Step 3: the composite support is mixed fully with an active phase precursor of iron and an active phase precursor of nickel in water and then dried, calcined and ground to produce a coral-reef-like bifunctional catalyst. The active phase precursor of iron includes a soluble iron salt and the active phase precursor of nickel includes a soluble nickel salt; in the active phase precursor of iron and the active phase precursor of nickel, the molar ratio of iron element to nickel element is 1:3 to 3:1; the mixing is carried out at the stirring speed of 600 to 900 r/min under the mixing temperature of 60 to 100° C. for a time of 2 to 3 hours; the calcination is carried out in an inert atmosphere at the calcination temperature of 700 to 900° C. for a time of 3 to 4 h.

The coral-reef-like bifunctional catalyst for biomass gasification to produce green hydrogen with simultaneous decarbonization, which is prepared in the embodiments of the present disclosure, includes a γ-Al₂O₃ support with regular tetrahedron structure and an active MgO support for decarbonization; the active metals iron and nickel are anchored to the oxygen vacancies of the γ-Al₂O₃ support and the loading of the active metals iron and nickel relative to the total weight of the catalyst is 8 wt. % to 10 wt. %.

The present disclosure will be further detailed in combination with specific examples, which is not intended to limit the present disclosure.

In each example of the present disclosure, for ease of comparison, the total weight of the composite support is controlled at 1 g, where the active metals iron and nickel have a total weight of 0.1 g, and the active metals iron and nickel have a loading of 9 wt. % relative to the total weight of the catalyst. The specific composition of the composite support and the contents of the active metals iron and nickel are shown in Table 1 below.

TABLE 1

| | | | | Contents | |
|---|---|---|---|---|---|
| | | Composite | | of the active | |
| | | support | | metals | |
| | | Mg | γ- | Fe | Ni |
| | Catalyst | (g) | Al₂O₃(g) | (g) | (g) |
| Example 1 | 3Fe1Ni/ | 0.2 | 0.8 | 0.074 | 0.025 |
| | 1MgO4Al₂O₃ | | | | |
| Example 2 | 1Fe1Ni/ | 0.2 | 0.8 | 0.049 | 0.051 |
| | 1MgO4Al₂O₃ | | | | |
| Example 3 | 1Fe3Ni/ | 0.2 | 0.8 | 0.024 | 0.075 |
| | 1MgO4Al₂O₃ | | | | |
| Example 4 | 3Fe1Ni/ | 0.5 | 0.5 | 0.074 | 0.025 |
| | 1MgO1Al₂O₃ | | | | |
| Example 5 | 1Fe1Ni/ | 0.5 | 0.5 | 0.049 | 0.051 |
| | 1MgO1Al₂O₃ | | | | |
| Example 6 | 1Fe3Ni/ | 0.5 | 0.5 | 0.024 | 0.075 |
| | 1MgO1Al₂O₃ | | | | |
| Example 7 | 3Fe1Ni/ | 0.8 | 0.2 | 0.074 | 0.025 |
| | 4MgO1Al₂O₃ | | | | |
| Example 8 | 1Fe1Ni/ | 0.8 | 0.2 | 0.049 | 0.051 |
| | 4MgO1Al₂O₃ | | | | |
| Example 9 | 1Fe3Ni/ | 0.8 | 0.2 | 0.024 | 0.075 |
| | 4Mgo1Al₂O₃ | | | | |

### Example 1

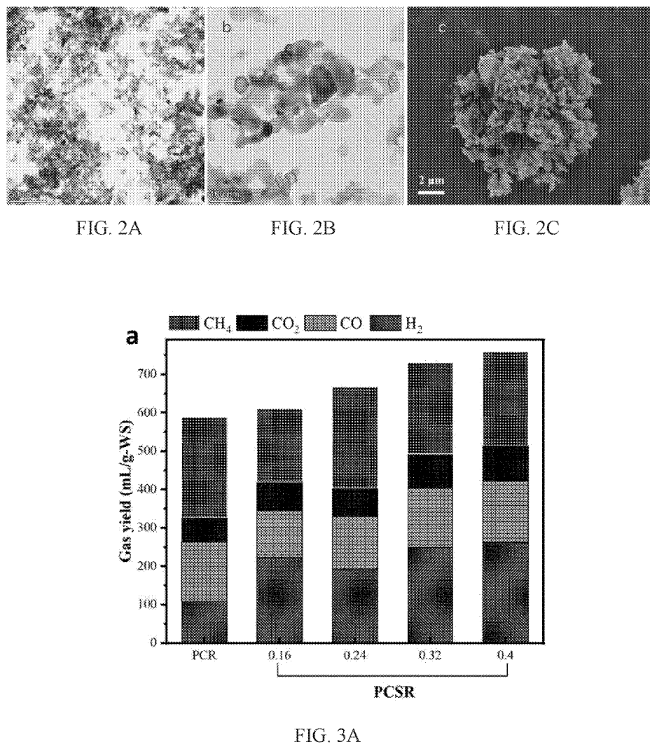

The example provides a preparation method of a coral-reef-like bifunctional catalyst for biomass gasification to produce green hydrogen with simultaneous decarbonization, which includes the following steps.
Step 1: 10 g of γ-Al₂O₃ was stirred for 3 hours in a 1 mol/L HNO₃ solution, and then washed to neutral by deionized water, then dried in 105° C. drying oven, and calcined for 3 h at the temperature of 900° C. in N₂ (99.99%) atmosphere with a flow rate of 50 mL/min to produce an activated γ-Al₂O₃ support; MgO powder was placed in in N₂ atmosphere and calcined for 2.5 h at the temperature of 800° C. to produce an activated magnesium oxide support.
Step 2:0.8 g of activated γ-Al₂O₃ support and 0.2 g of activated MgO support were mixed to obtain 1 g of composite support.
Step 3: Ni(NO₃)₂·6H₂O and Fe(NO₃)₃·9H₂O were selected as catalyst precursor. 0.5244 g of Fe(NO₃) 3.9H₂O and 0.1250 g of Ni(NO₃)₂·6H₂O were dissolved in 10 ml of deonized water and fully stirred to fully dissolved, and then added with 1 g of composite support. The suspension was stirred continuously for 2 hours at the temperature of 60° C. and then transferred to 105° C. drying oven until its moisture was fully evaporated. The product was dried and then calcined for 3 hours in the nitrogen atmosphere of 800° cand ground to produce a yellowish 3Fe1Ni/1MgO4Al₂O₃ catalyst, where the SEM diagram and TEM diagram of the catalyst were shown in FIGS. 2A-2C.

### Examples 2 to 9

The preparation method and flow of the examples 2 to 9 are basically same as in the example 1 except the difference: in the examples 2 to 9, the catalyst is prepared according to the composition and usage of the composite support and the content of the active metals in Table 1.

### Application Example

### (1) Catalytic Activity Test of the Catalyst

In the application example, the application performance of the catalyst prepared in each example in the preparation of a bio-based hydrogen-rich synthesis gas is investigated. The specific test method is as follows: the catalyst is applied to the preparation of the hydrogen-rich synthesis gas by thermal conversion of biomass, which includes the following flow:

Based on the weight ratio 1:1 of the biomass feedstock to the coral-reef-like catalyst, 1.0 g of wheat straw with a particle size of 60 to 80 meshes and 1.0 g of catalyst prepared in each example are prepared. The application experiment is carried out in a three-level fixed bed reactor. First, the reaction device is installed, and the device airtightness is inspected and then N₂ is blow into the reactor system continuously till no oxygen at the outlet. Then, a temperature controller panel is adjusted to heat the reactor to its desired temperature. The temperature of the upper zone is 600° C. and the pyrolysis temperature of the lower zone is 800° C. After the set temperature is reached, the gasifying agent of 4.8 mg/g (0.24 mL/min) is introduced into the reactor with the carrier gas (N₂) of the bed velocity of 0.11 m/min (200 mL/min).

1 g of catalyst prepared in advance is placed on the top, and 1 g of biomass is placed into a quartz crucible and fixed at bottom. Then, a basket and the quartz crucible are pushed into the reactor for reaction of 40 min. After the reaction is completed, a cooling system is turned on, and an online gas monitoring device is connected to the dryer and at the same time, the gas composition in the reactor is detected. The gas composition is quantitatively analyzed by a gas analyzer.

The production of the synthesis gas is calculated in the formula (1).

$${Y}_{i} = {\int }_{0}^{t} {X}_{i} dt / m \qquad ( 1 )$$

where i represents a different component in the synthesis gas, such as H₂, CO, CO₂ or CH₄; m represents a feedstock weight of each experiment; Xᵢ (mL/g) represents a real-time yield of the synthesis gas; t represents a reactor time; and Yᵢ (mol/g) represents a total yield of the synthesis gas.

H₂/CO is an important index for assessing the reactor effect, with its calculation formula (2) below:

$$\frac{{H}_{2}}{CO} = \frac{{C}_{{H}_{2}}}{{C}_{CO}} \qquad ( 2 )$$

where C_{H2}, C_{CO} (Vol. %) represents a volume concentration of H₂ and CO in the synthesis gas.

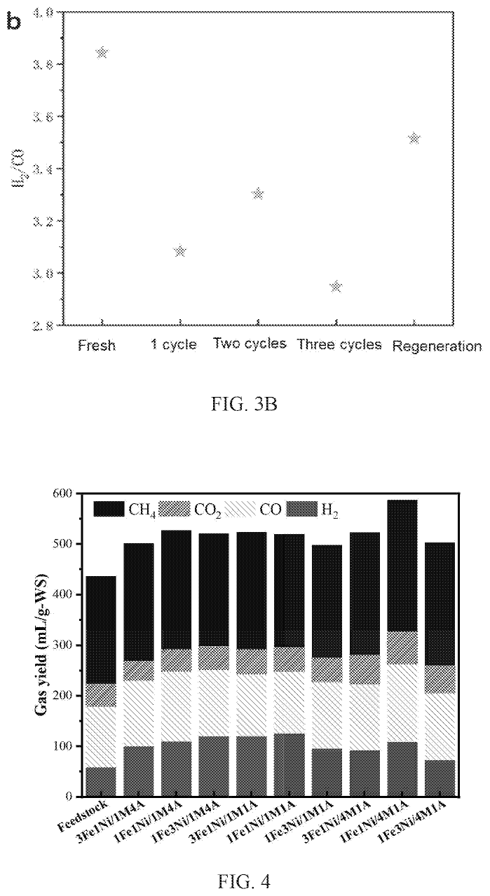

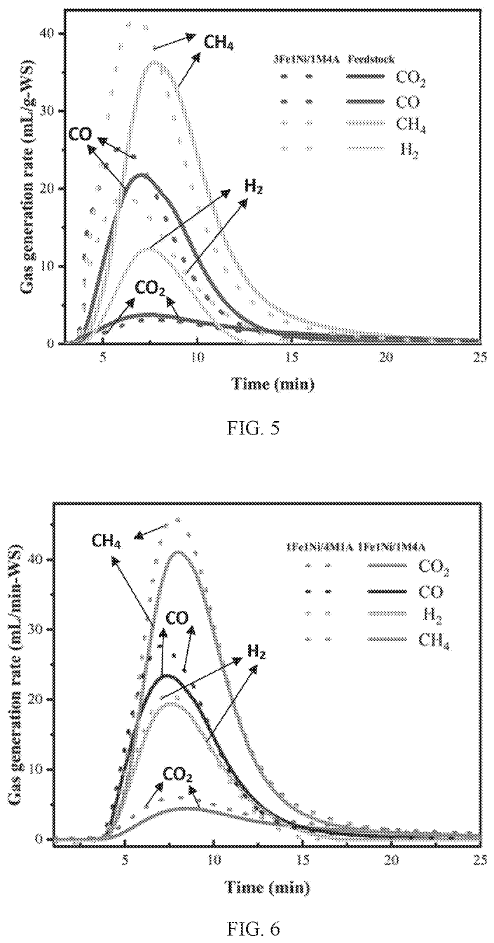

FIGS. 3A to 6 show the content of each component and H₂/CO in the synthesis gas under the effect of the catalysts prepared in the examples 1 to 9. Table 2 shows the yield of each component in the synthesis gas in the above application of the examples 1 to 9 and the blank sample without catalyst (no gasifying agent is added and only the effect of the catalyst on the processes of bond cleavage and decarbonylation in pathway 1 was investigated).

TABLE 2

| | | H₂ yield | CO yield | CO₂ yield |
|---|---|---|---|---|
| | Catalyst | (mL/g) | (mL/g) | (mL/g) |
| Control | feedstock | 58 | 120 | 44 |
| example | | | | |
| Example 1 | 3Fe1Ni/ | 99 | 130 | 38 |
| | 1MgO4Al₂O₃ | | | |
| Example 2 | 1Fe1Ni/ | 123 | 131 | 43 |
| | 1MgO4Al₂O₃ | | | |
| Example 3 | 1Fe3Ni/ | 119 | 126 | 46 |
| | 1MgO4Al₂O₃ | | | |
| Example 4 | 3Fe1Ni/ | 119 | 123 | 49 |
| | 1MgO1Al₂O₃ | | | |
| Example 5 | 1Fe1Ni/ | 125 | 122 | 48 |
| | 1MgO1Al₂O₃ | | | |
| Example 6 | 1Fe3Ni/ | 95 | 139 | 47 |
| | 1MgO1A1₂O₃ | | | |
| Example 7 | 3Fe1Ni/ | 92 | 130 | 58 |
| | 4MgO1A1₂O₃ | | | |
| Example 8 | 1Fe1Ni/ | 108 | 154 | 56 |
| | 4MgO1Al₂O₃ | | | |
| Example 9 | 1Fe3Ni/ | 72 | 133 | 55 |
| | 4MgO1A1₂O₃ | | | |

From Table 2 and the FIGS. 3A to 6, it can be seen that:

Compared with the blank sample, the application of the catalysts prepared in the examples 1 to 9 can noticeably increase the total production of the synthesis gas, the content of the hydrogen in the synthesis gas is increased obviously, and the content of the carbon dioxide is slightly decreased. Furthermore, under the condition of same support, when the molar ratio of the active components iron to nickel in the catalyst is controlled to 1:1, the hydrogen production is maximal. Compared with other examples, when the molar ratio of iron to nickel is controlled to 1:1 and the weight ratio of the magnesium oxide support to the aluminium oxide support is controlled to 4:1 in the example 8, the carbon monoxide production is maximal, which indicates that the increase of the proportion of the active magnesium oxide in the composite support helps to lower the content of carbon dioxide in the synthesis gas and increase the production of carbon monoxide, proving the active magnesium oxide support can promote the deoxygenation effect of carbon dioxide.

Furthermore, FIG. 3A displays a gas product distribution under the condition of different water steam injection rates in the application of the catalyst prepared in the example 1; when the water steam injection rate is 0.24 mL/min, the molar ratio of H₂/CO is 3.84.

### (II) Cycling Performance and Regeneration Performance Test of the Catalyst

The method of the cycling performance test is as follows: according to the method of the catalytic activity test of the catalyst (I), after the reaction is completed, new biomass feedstock is put in again for catalyst cycling test, and the content of each component in the gas test synthesis gas is collected and five cycles are repeated like this.

The method of the regeneration performance test is as follows: the catalyst going through five cycles is taken out and put into a quartz crucible and then placed in a tubular furnace. The tubular furnace is heated to 700° C. at a heating rate of 10° C./min under atmospheric pressure in air atmosphere, and held for 30 min for catalyst regeneration. The regenerated catalyst is used for a catalytic pyrolysis experiment of biomass, where the experimental process and the gas detection method are same as in the catalytic activity test of the catalyst (I).

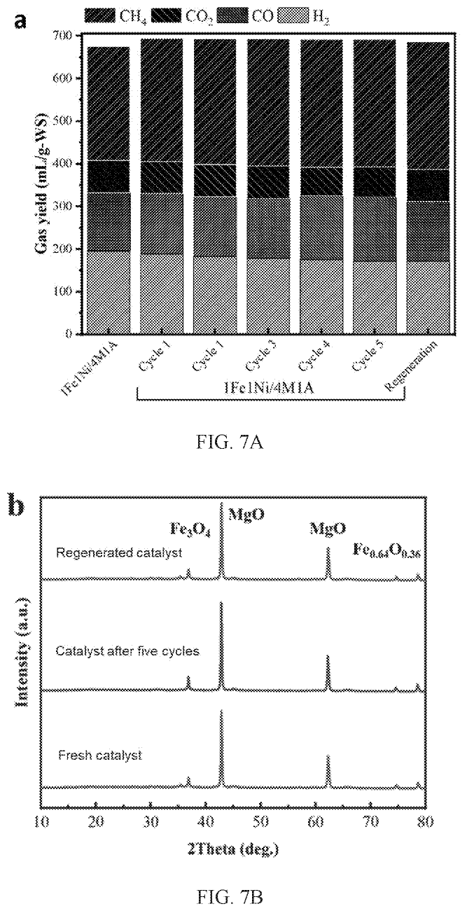

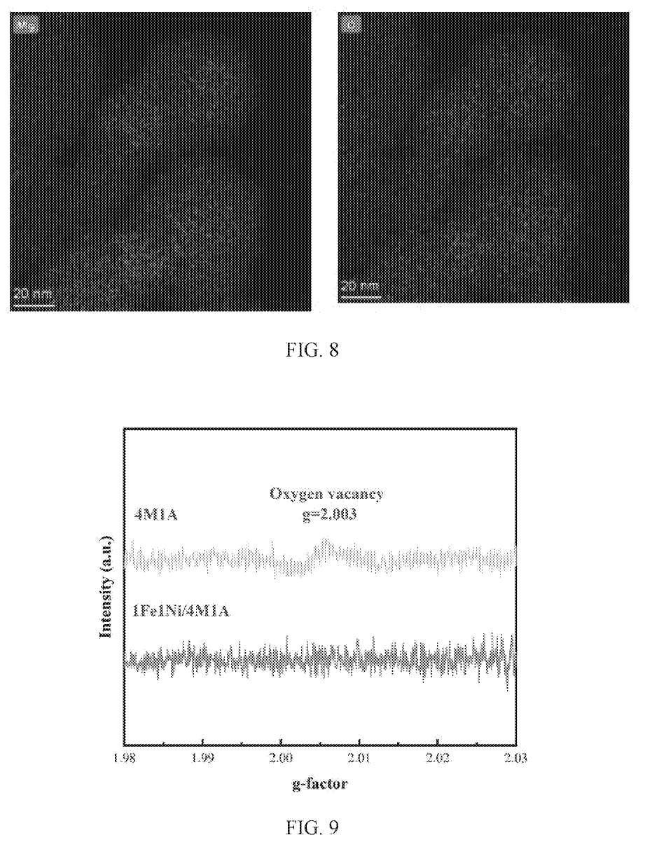

FIGS. 7A-7B show a result of the cycling performance test of the 1Fe1Ni/4MgO1Al₂O₃ catalyst prepared in the example 8. From FIGS. 7A-7B, it can be seen that the catalyst prepared in the present disclosure, after going through five cycles and regenerations, still maintains the coral-reef-like special morphology and the dual active sites are not changed, and the cycled catalyst has no carbide phase, which indicates that the catalyst has carbon deposition resistance. Furthermore, in the cycling and regeneration process of the catalyst, the active magnesium oxide support is basically un-carbonated in the catalytic reaction process (in the XRD data in FIGS. 7A-7B, no diffraction peak of MgCO₃ is found), which indicates that the active magnesium oxide realizes carbon dioxide deoxygenation (MgO+CO₂→MgO(O)+CO) by abstracting one oxygen atom from CO₂ to form an MgO(O) intermediate. Furthermore, the edx-mapping diagram of FIG. 8 also proves the magnesium oxide is not carbonated and exists in the form of magnesium oxide.

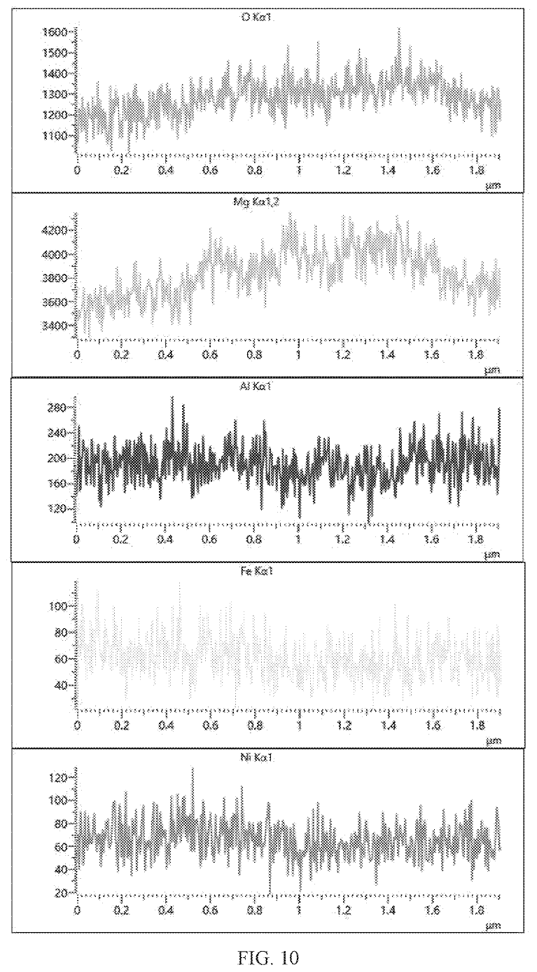

FIGS. 9 and 10 show the RPR data and EDX pictures of the 1Fe1Ni/4MgO1Al₂O₃ catalyst prepared in the example 8. From FIGS. 9 and 10, it can be seen that after the active phase is added, the peak representing the oxygen vacancies disappears, which indicates that a part of active metals are anchored to the oxygen vacancies. Compared with the active components loaded on the surfaces and pores of the support in the preparation of other catalysts, with aluminum oxide as support in the present disclosure, the aluminum oxide support goes through the activation of calcination and then acid leaching to increase the oxygen vacancies of the surface of the aluminum oxide support, and subsequently, the supported active metals can be accurately and firmly anchored to the skeleton of aluminum oxide through oxygen vacancies. It is not easy for the active metals to suffer peeling and high-temperature change in multiple cycles and regenerations under high temperature, further maintaining better structural stability and cycling stability.

The above are only preferred examples of the present disclosure, and are not intended to limit the implementations and scope of protection of the present disclosure. Those skilled in the arts shall be aware that all schemes derived from those equivalent replacements and obvious changes made based on the contents of the specification of the present disclosure shall fall within the scope of protection of the present disclosure.

What is claimed is:

1. A preparation method of a coral-reef-like bifunctional catalyst for biomass gasification to produce green hydrogen with simultaneous decarbonization, comprising the following steps:
S1, an aluminum oxide support goes through acid leaching, calcination, and grinding to produce an activated aluminum oxide support; magnesium oxide is calcined and ground to produce an activated magnesium oxide;
S2, the activated aluminum oxide support and the activated magnesium oxide are mixed to produce a composite support;
S3, the composite support is mixed fully with an active phase precursor of iron and an active phase precursor of nickel in water and then dried, calcined, and ground to produce the coral-reef-like bifunctional catalyst.

2. The preparation method according to claim 1, wherein in the step S1, the aluminum oxide support is γ-Al₂O₃; the acid leaching uses a nitric acid solution with a concentration of 0.1 to 2 mol/L and an acid leaching time is 2 to 4 h; a calcination temperature of the aluminum oxide support is 600 to 900° C., and a time is 2 to 4 h; the calcination is carried out in an inert atmosphere.

3. The preparation method according to claim 1, wherein in the step S1, a calcination temperature of the magnesium oxide is 700 to 900° C. and a time is 1.5 to 3.5 h; the calcination is carried out in an inert atmosphere.

4. The preparation method according to claim 1, wherein in the step S2, in the composite support, a weight ratio of the activated aluminum oxide support to the activated magnesium oxide is 1:4 to 4:1.

5. The preparation method according to claim 1, wherein in the step S3, the active phase precursor of iron comprises a soluble iron salt and the active phase precursor of nickel comprises a soluble nickel salt.

6. The preparation method according to claim 1, wherein in the step S3, in the active phase precursor of iron and the active phase precursor of nickel, a molar ratio of iron element to nickel element is 1:3 to 3:1.

7. The preparation method according to claim 1, wherein in the step S3, the mixing is carried out at a stirring speed of 600 to 900 r/min under a mixing temperature of 60 to 100° C. for a time of 2 to 3 h; the calcination is carried out in an inert atmosphere at a calcination temperature of 700 to 900° C. for a time of 3 to 4 h.

8. A coral-reef-like bifunctional catalyst for biomass gasification to produce green hydrogen with simultaneous decarbonization, prepared by the preparation method according to claim 1, wherein the coral-reef-like bifunctional catalyst comprises a γ-Al₂O₃ support with regular tetrahedron structure and an active MgO support for decarbonization; active metals iron and nickel are anchored to oxygen vacancies of the γ-Al₂O₃ support and loading of the active metals iron and nickel relative to a total weight of the catalyst is 8 wt. % to 10 wt. %.

9. An application of the coral-reef-like bifunctional catalyst according to claim 8 in preparation of a bio-based hydrogen-rich synthesis gas, wherein a dried biomass feedstock is mixed with the coral-reef-like bifunctional catalyst at a ratio, and pyrolysis reaction is performed with water as gasifying agent to prepare the hydrogen-rich synthesis gas; in the hydrogen-rich synthesis gas, a molar ratio of H₂ to CO is 2 to 4.

10. The application according to claim 9, wherein a deactivated catalyst after use goes through combustion treatment at a combustion treatment temperature of 600 to 800° C. for a time of 30 to 80 min to produce a regenerated catalyst.

11. The coral-reef-like bifunctional catalyst according to claim 8, wherein in the step S1 of the preparation method, the aluminum oxide support is γ-Al₂O₃; the acid leaching uses a nitric acid solution with a concentration of 0.1 to 2 mol/L and an acid leaching time is 2 to 4 h; a calcination temperature of the aluminum oxide support is 600 to 900° C., and a time is 2 to 4 h; the calcination is carried out in an inert atmosphere.

12. The coral-reef-like bifunctional catalyst according to claim 8, wherein in the step S1 of the preparation method, a calcination temperature of the magnesium oxide is 700 to 900° C. and a time is 1.5 to 3.5 h; the calcination is carried out in an inert atmosphere.

13. The coral-reef-like bifunctional catalyst according to claim 8, wherein in the step S2 of the preparation method, in the composite support, a weight ratio of the activated aluminum oxide support to the activated magnesium oxide is 1:4 to 4:1.

14. The coral-reef-like bifunctional catalyst according to claim 8, wherein in the step S3 of the preparation method, the active phase precursor of iron comprises a soluble iron salt and the active phase precursor of nickel comprises a soluble nickel salt.

15. The coral-reef-like bifunctional catalyst according to claim 8, wherein in the step S3 of the preparation method, in the active phase precursor of iron and the active phase precursor of nickel, a molar ratio of iron element to nickel element is 1:3 to 3:1.

16. The coral-reef-like bifunctional catalyst according to claim 8, wherein in the step S3 of the preparation method, the mixing is carried out at a stirring speed of 600 to 900 r/min under a mixing temperature of 60 to 100° C. for a time of 2 to 3 h; the calcination is carried out in an inert atmosphere at a calcination temperature of 700 to 900° C. for a time of 3 to 4 h.

17. The application according to claim 9, wherein in the step S1 of the preparation method, the aluminum oxide support is γ-Al₂O₃; the acid leaching uses a nitric acid solution with a concentration of 0.1 to 2 mol/L and an acid leaching time is 2 to 4 h; a calcination temperature of the aluminum oxide support is 600 to 900° C., and a time is 2 to 4 h; the calcination is carried out in an inert atmosphere.

18. The application according to claim 9, wherein in the step S1 of the preparation method, a calcination temperature of the magnesium oxide is 700 to 900° C. and a time is 1.5 to 3.5 h; the calcination is carried out in an inert atmosphere.

19. The application according to claim 9, wherein in the step S2 of the preparation method, in the composite support, a weight ratio of the activated aluminum oxide support to the activated magnesium oxide is 1:4 to 4:1.

20. The application according to claim 9, wherein in the step S3 of the preparation method, the active phase precursor of iron comprises a soluble iron salt and the active phase precursor of nickel comprises a soluble nickel salt.
